(19) United States
(12) Patent Application Publication
(10) Pub. No.: US 2026/0193035 A1
(43) Pub. Date: Jul. 9, 2026

(54) SORTING AND STORAGE PLANT FOR SLABS

(71) Applicant: SYSTEM CERAMICS S.P.A., FIORANO MODENESE (MODENA) (IT)

(72) Inventor: ANDREA TORO, FIORANO MODENESE (MODENA) (IT)

(21) Appl. No.: 19/132,182

(22) PCT Filed: Nov. 7, 2023
(86) PCT No.: PCT/IB2023/061228

§ 371 Date: May 22, 2025

(30) Foreign Application Priority Data
Nov. 23, 2022 (IT) 102022000024123

(51) Int. Cl. B65G 1/04; B65G 47/91; B65G 49/06

(52) U.S. Cl. CPC B65G 1/04; B65G 47/914; B65G 49/061; B65G 2201/022

(57) ABSTRACT

A sorting and storage plant for slabs that includes a warehouse, provided with a plurality of containing spaces and a manipulator, set up for grasping and releasing a slab, and for displacing the slab between an accessory position and one or more containing spaces. The warehouse includes at least one rack having a plurality of sidewalls parallel to each other and aligned along a longitudinal direction, wherein two adjacent sidewalls define a containing space for one or more slabs arranged on a plane with a slight tilt with respect to a vertical plane. The manipulator has a gripping device, which is movable between a first position, in which it is able to grasp or release slab positioned in the accessory position, and a second position, in which it is able to insert itself into a containing space to release or pick up a slab.

The present invention relates to a sorting and storage plant for slabs. In particular, but not exclusively, the invention finds useful use in storing large-sized ceramic slabs.

In the ceramic tile production industry, a technology that allows large-format slabs up to 4000×2000 mm to be made is now consolidated.

As part of the overall production cycle, the slabs must be stored, waiting to be sent to subsequent processing or to be transported to the end user or to a point of sale.

Currently, the slabs are substantially stored in two modes.

In a first mode, the slabs are stored in stacks, formed by a certain number of slabs arranged horizontally and stacked on one another. Given the great weight of the slabs of such great dimensions, it is not possible to stack more than a certain number of slabs. This involves the need to store the slabs in a great number of stacks, occupying in total rather a wide surface compared with the number of stored slabs.

In a second mode, the slabs are stored on temporary supports, defined by a sidewall that rises from a support base. The slabs are arranged with one side resting on the base of the temporary support, and reclined to rest on the median sidewall, so as to assume a position close to vertical. The temporary supports can be placed on the ground or be stacked on two or three levels. This solution enables the number of slabs that are storable on the same occupied surface to be increased slightly. On the other hand, such raised positioning forces bulky and costly support structures to be created, given the significant weight that they are designed to support.

The object of the present invention is to provide a sorting and storage plant for slabs which enables the drawbacks of the currently known warehouses to be obviated.

An advantage of the plant according to the present invention is to store a greater number of slabs on the same occupied surface than with current warehouses. Indicatively, the plant according to the present invention enables four times the quantity of slabs to be stored on the same occupied surface compared with current warehouses.

Another advantage of the plant according to the present invention is to allow a simple and effective movement of the slabs entering and of the slabs exiting the plant.

A further advantage of the plant according to the present invention is to simplify and speed up the composition of groups of different slabs exiting the warehouse plant.

Further features and advantages of the present invention will become more apparent from the following detailed description of an embodiment of the invention in question, illustrated by way of non-limiting example in the appended figures, in which:

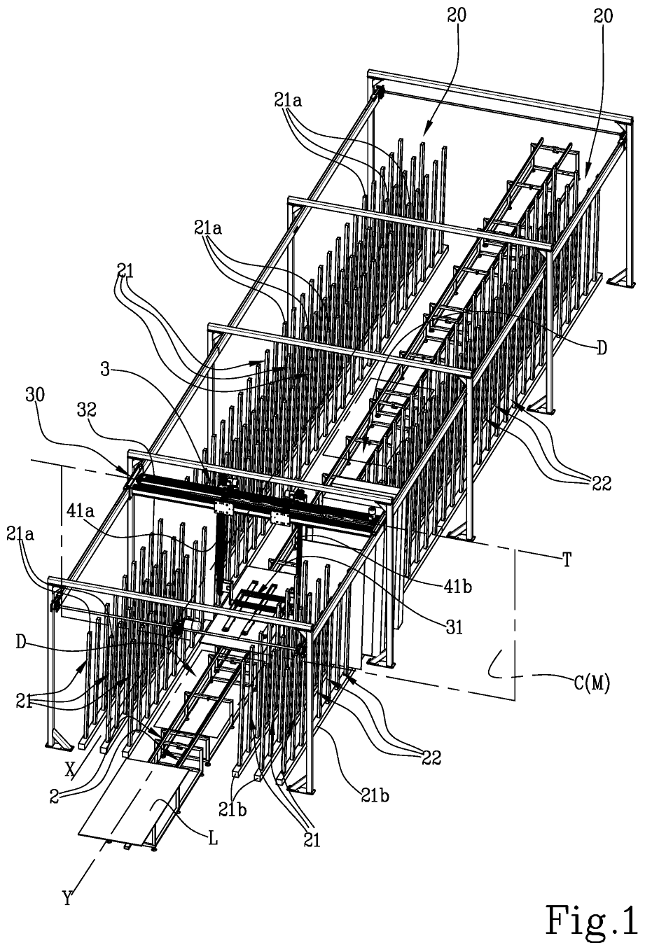

FIG. 1 is a schematic view of the plant according to the present invention;

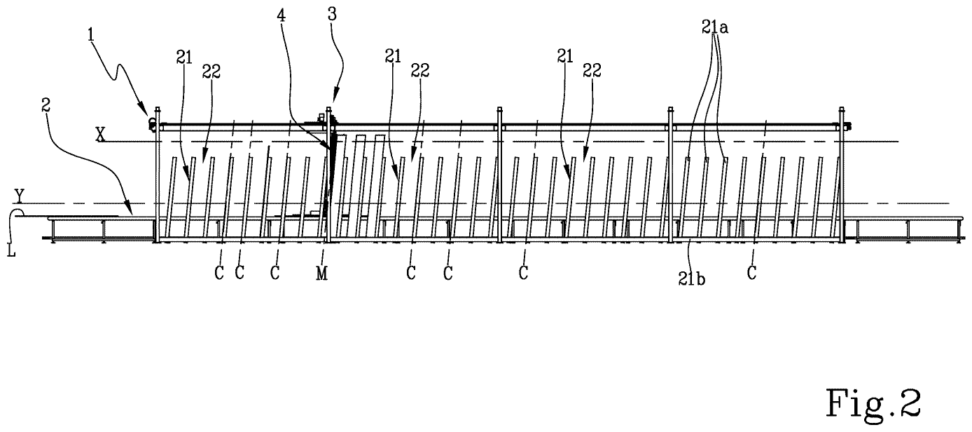

FIG. 2 is a lateral view of the plant according to the present invention;

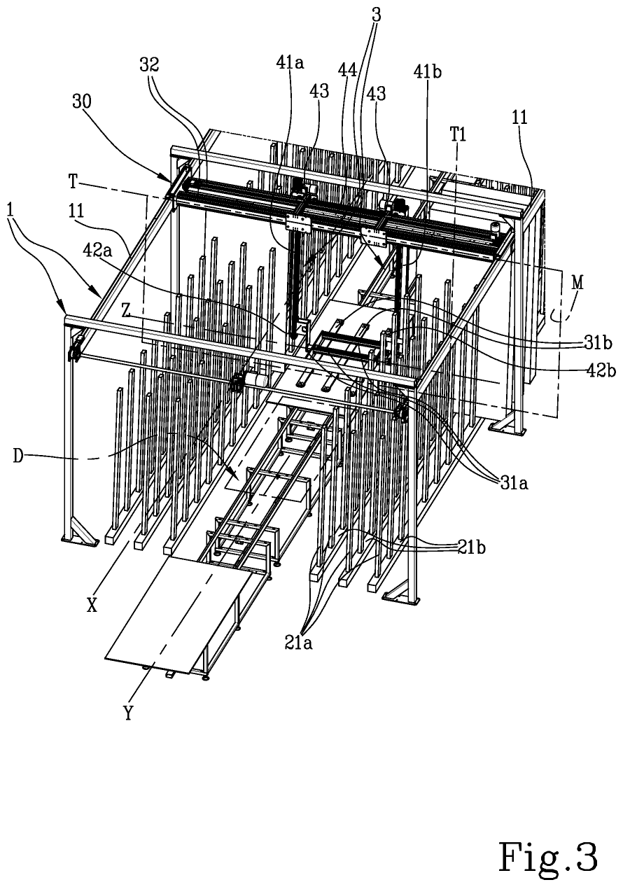

FIGS. 3,4,5,6 show a portion of the plant of FIG. 1, in different operating phases;

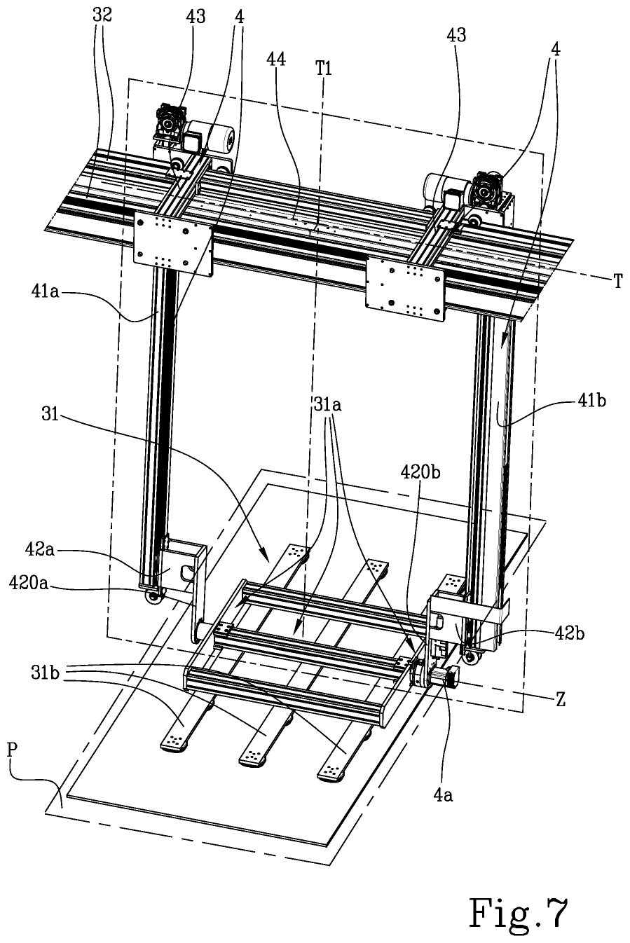

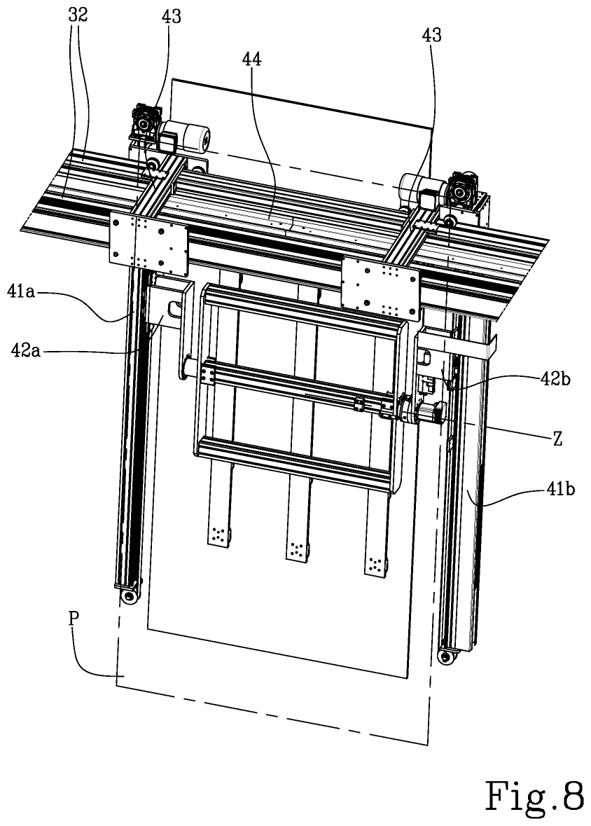

FIGS. 7 and 8 show a device of the plant in two different operating positions.

In the following description, generic reference will be made to slabs (L), which are understood to be products provided with two opposing rectangular main surfaces, delimited by sides whose length is much greater than the thickness of the slab, which is understood to be the distance that separates the two main surfaces.

In the case of ceramic slabs, one of the two main surfaces is the laying or installation surface, i.e. the surface intended to be hooked to the support structure, typically by means of specific mortars or adhesives, the other one is the visible surface, intended to remain exposed after the slab is laid.

The plant according to the present invention is nevertheless suitable for managing any type of slab.

In the case of ceramic slabs, one of the two main surfaces is the laying or installation surface, i.e. the surface intended to be hooked to the support structure, typically by means of specific mortars or adhesives, the other one is the visible surface, intended to remain exposed after the slab is laid.

In the following description, reference will also be made to motors for the movement and/or rotation of various components of the sorting machine, without the motors being described in detail. The term motor is intended to mean an actuator capable of causing the movement of one part or component with respect to another part or component, with or without interposition of a kinematic transmission mechanism, which may for example comprise gears, belts, rollers or other transmission systems that are well known in the industry. The motor is preferably an electric motor, possibly provided with an encoder to allow a precise control thereof by a main processor. This main processor coordinates the activations of the various motors between them in order to obtain pre-established movements.

In addition, in the following description reference will be made to sliding guides, not described in detail, used to facilitate the relative sliding between its parts or components of the sorting machine. The term sliding guide is intended to mean a device, well known in the industry, structured to be interposed between two parts or components intended to slide or rotate with respect to each other. The sliding guides used in the sorting machine according to the present invention may be with rollers, wheels, balls, skids or other equivalent configurations, which are all known in the industry.

The sorting and storage plant for slabs according to the present invention comprises a warehouse (20,21), provided with a plurality of containing spaces (22), each intended to contain one or more slabs (L).

The warehouse (20,21) comprises at least one first rack (20), provided with a plurality of sidewalls (21). Each sidewall (21) defines a rest plane (C) that is oriented with a slight tilt with respect to a vertical plane. In other words, each sidewall (21) is structured to define a plane that is substantially vertical or slightly tilted with respect to the vertical plane, suitable for enabling at least one slab (L) resting on a side and arranged parallel to the rest plane (C) to be supported.

Each sidewall (21) is structured to support at least one slab arranged resting on a side and slightly tilted so as to rest the opposite side on the sidewall (21), being arranged substantially parallel to the rest plane (C), or adopting an orientation that is slightly tilted with respect to the vertical. For example, the sidewalls (21) are tilted in a concordant manner by about 3-4° with respect to a vertical plane, so that the rest plane (C) is also tilted by about 3-4° with respect to a vertical plane.

The sidewalls (21) are arranged transversely to a longitudinal direction (Y), and are distributed in a row parallel to the longitudinal direction (Y). In particular, the intersection between the sidewalls (21) and a plane containing the longitudinal direction (Y) is defined by a bundle of segments parallel to one another and perpendicular to the longitudinal direction (Y).

Preferably, the longitudinal direction (Y) is horizontal.

Two consecutive sidewalls (21) face one another and define a containing space (22) for one or more slabs (L) arranged as disclosed above. A first slab (L) rests on a sidewall (21), whereas the other slabs (L) contained in the same containing space (22) rest consecutively on one another and on the first slab (L). The slab (L) further from the sidewall (21), or the last slab (L) of the group resting on the same sidewall (21), is the accessible slab (L), i.e. the slab that can be reached and hooked by a gripping means that will be disclosed below. Obviously, the tilt of the slabs (L) resting on the same sidewall (21) increases slightly, moving from the first to the last slab, but is always maintained near the vertical.

In the plant according to the present invention, the slabs (L) are adjacent to one another with an orientation near vertical. The number of slabs that can be stored using a rack (20) on the same occupied surface is thus significantly greater that the number of slabs that be stored piled up in stacks.

Preferably, each sidewall (21) is defined by at least two bars (21a), lying on a plane parallel to the rest plane (C). In the embodiment shown, each sidewall (21) is defined by three bars (21a). Preferably, the bars (21a) are connected to rest profiles (21b), arranged substantially parallel to the longitudinal direction (Y). The connection between the bars (21a) and the rest profiles (21b) is preferably removable. This enables the bars (21a) to be repositioned rapidly to modify the structure and/or the capacity of the containing spaces (22).

The plant according to the present invention further comprises a manipulator (3), set up for grasping and releasing a slab (L), and for displacing the slab (L) between an accessory position (D) and one or more containing spaces (22).

The manipulator (3) comprises a gripping device (31), associated movably with a support structure (4) that defines a displacement plane (M) of the gripping device (31). In other words, the gripping device (31) is able to translate on the displacement plane (M) by means of motor means that will be disclosed better below.

The displacement plane (M) is parallel to the rest plane (C). By moving on the displacement plane (M), the gripping device (31) is able to insert itself into a containing space (22) in order to release or pick up a slab (L).

The fact that the displacement plane (M) is parallel to the rest plane (C) enables the gripping device (31) to exploit effectively most of each containing space (22). In fact, if the distance between two adjacent sidewalls measured perpendicularly to the rest plane (C) is considered, the free space that is necessary for there to be no interference with the sidewalls (21) is limited substantially to the total height of the gripping device (31) and of the maximum number of slabs (L) intended for the containing space (22). The sidewalls (21) can then be arranged at a relatively reduced distance, and without the need to set up complex mechanisms to enable two consecutive sidewalls to be enlarged whenever it is necessary to insert the gripping device (31), as occurs in plants of known type.

The gripping device (31) comprises a gripping plane (P). In substance, the gripping plane (P) is the plane at which a slab (L) is gripped by the gripping device (31).

The gripping device (31) rotates around a rotation axis (Z), lying on the displacement plane (M), to adopt at least one insertion position, in which the gripping plane (P) is parallel to the rest plane (C). In the insertion position, the overall dimensions of the gripping device (31), measured perpendicularly to the rest plane (C), is minimal, so as to permit a significant reduction in the distance between two consecutive sidewalls (21).

The gripping device (31) is movable on the displacement plane (M) along at least two perpendicular directions. Preferably, one of these two perpendicular directions is substantially horizontal, or has a horizontal component. This enables the gripping device (31) to be inserted into a containing space (22) starting from a position that is lateral to the containing space (22).

In the embodiment shown, the manipulator (3) is movable next to the rack (20) along a sliding direction (X) parallel to the longitudinal direction (Y). For example, the manipulator (3) is movable along a rectilinear guide, in a manner that is known to the expert person.

As already specified, the manipulator (3) is movable between an accessory position (D) and each of the containing spaces (22), i.e. the manipulator (3) is able to reach each containing space (22) and the accessory position (D).

This accessory position (D) is substantially an area inside which a slab (L) is intended to stay or be positioned by the manipulator (3). Preferably, the accessory position (D) lies on a horizontal plane

In one possible embodiment, the accessory position (D) is static. In another possible embodiment, the accessory position (D) is movable. For example, the accessory position (D) is located on a conveying device (2) that will be disclosed better below.

The gripping device (31) is structured for being inserted into a containing space (22) and for picking up or releasing at least one slab (L), and for being inserted into each of the containing spaces (22), to pick up or deposit a slab (L). For example, to deposit a slab (L) in a set containing space (22), the manipulator (3) moves to the accessory position (D) and, by means of the gripping device (31), picks up the slab (L). Subsequently, the manipulator (3) moves along the rack (20), going to the containing space (22) provided for the slab. At the containing space (22) provided, the gripping device (31) is inserted into the containing space (22) provided, depositing the slab (L) there.

Similarly, if picking up a slab (L) is required, the manipulator (3) moves to the containing space (22) of the slab (L). Subsequently, the gripping device (31) is inserted into the containing space and picks up the accessible slab (L) of the group located in the containing space. Once the slab (L) is picked up, the gripping device (31) deposits the slab at the accessory position (D). The combination between the rack (20) and the manipulator (3) thus enables the slabs (L) to be moved very simply and effectively, both into the plant and out of the plant.

In order to increase the capacity of the automatic warehouse, a second rack (20) can be arranged parallel to the longitudinal direction (Y) and to the first rack (20). In this case, the manipulator (3) is movable between the first and the second rack, along a corridor parallel to both. The gripping device (31) is able to access the containing spaces (22) of both racks (20). The capacity of the warehouse can be increased depending on the needs, by arranging a plurality of parallel and adjacent racks (20). One or two manipulators (3) can be placed in each corridor interposed between two adjacent racks (20). Each manipulator (3) is managed by the main control system of the plant in the modes disclosed above.

As already stated, the gripping device (31) comprises a gripping plane (P), at which gripping takes place. In other words, the gripping plane (P) is intended to be positioned in contact with the surface of the object to be picked up. In the insertion position of the gripping device (31), the gripping plane (P) is substantially parallel to the rest plane (C).

In particular, the gripping device (31) comprises gripping means that defines the gripping plane (P). For example, the gripping means comprises a plurality of suction cups.

The gripping device (31) rotates around a rotation axis (Z), between the insertion position, in which the gripping plane (P) is parallel to the rest plane (C), and a second position, in which the gripping plane (P) is substantially parallel to the plane on which the accessory position (D) lies. Preferably, in the second position, the gripping plane (P) is substantially horizontal.

Preferably, the support structure (4) of the manipulator (3) comprises at least one upright (41a), arranged lying on the displacement plane (M).

In particular, the support structure (4) comprises a slider (42a) that is slidable along the upright (41a), with which the gripping device (31) is associated rotating around the rotation axis (Z). The slider (42a) is slidable along the upright (41a) by means of a guide and of a motor device known to the skilled person.

In the embodiment shown, the support structure (4) comprises a second upright (41b), which is substantially parallel to and coplanar with the first upright (41a), and a second slider (42b), which is slidable along the second upright (41b), with which the gripping device (31) is associated rotating around the rotation axis (Z). The gripping device (31) is substantially comprised between the two uprights (41a,41b), and is supported slidably by the two uprights (41a,41b) on the displacement plane (M) and rotating around the rotation axis (Z). The location of the gripping device (31) between the two uprights (41a,41b), that lie on a plane parallel to the containing plane (C), enables the overall dimensions to be reduced significantly measured in a direction perpendicular to the containing plane (C) of the group formed by the support structure (4) and by the gripping device (31).

In the embodiment shown, the gripping device (31) is associated with the sliders (42a,42b). In particular, two sides of the frame (31a) are associated with the sliders (42a, 42b) rotating around the rotation axis (Z), by means of respective rotary joints known in the industry. As already specified, the rotation of the frame (31a) around the rotation axis (Z) is obtained by the motor (4a), connected to at least one side of the frame (31a), by a transmission known in the industry. Preferably, the motor (4a) is associated with one of the sliders (42a,42b).

In turn, the sliders (42a, 42b) are slidable along the uprights (41a, 41b) by at least one motor. Preferably, each slider (42a, 42b) is slidable by a respective motor associated with the carriage (30). Each motor is connected to the respective slider (42a, 42b) by means of a kinematic mechanism known in the industry.

Preferably, each slider (42a,42b) is provided with a respective arm (420a,420b). The arms (420a,420b) are coplanar with the displacement plane (M) and protrude downwards from the rotation axis (Z). In this manner, in a lower position of the sliders (42a,42b), near the lower ends of the uprights (41a,41b), the gripping device (31) and the gripping plane (P) can be positioned below the uprights (41a,41b) to reach the accessory position (D). This further enables any interference to be avoided between the uprights (41a,41b) and the underlying accessory position (D), especially if the accessory position is located on a conveying plane (2) that will be disclosed further on.

By vertically moving the gripping device (31), it is possible to bring the gripping means (31) to the height of the accessory position (D), to pick up or release a slab (L), and to the height of the different containing spaces (22), to pick up or release a slab (L).

In the illustrated preferred but not exclusive embodiment, the gripping device (31) is movable on the displacement plane (M) along at least one substantially horizontal transverse direction (T). The transverse direction (T) is perpendicular to the longitudinal direction (Y). Along the transverse direction (T), the gripping device (31) is movable between at least one first position, in which it is located in a position superimposed vertically on the accessory position (D), and at least one second position, in which the gripping device (31) is arranged inside a containing space (22). The gripping device (31) is further movable on the movement plane (M) along an ascent-descent direction (T1), which is perpendicular to the transverse direction (T).

In a possible alternative embodiment that is not shown the station or the accessory stations (D) present are arranged aligned on a rack (20) along the longitudinal direction (Y). In other words, one or more operating stations (D) can be located at the ends of the rack (20) along the longitudinal direction (Y). In this case, the displacement of the gripping device (31) along the transverse direction (T) is not necessary but the displacement along the ascent-descent direction (31) is sufficient.

In the illustrated preferred but not exclusive embodiment, the manipulator (3) comprises a carriage (30) that is movable along a substantially horizontal sliding direction (X). Preferably, but not necessarily, the sliding direction (X) is parallel to the longitudinal direction (Y). The support structure (4) is associated with the carriage (30).

As already specified, the gripping device (31) rotates around a substantially horizontal rotation axis (Z). Preferably, but not necessarily, the rotation axis (Z) is substantially perpendicular to the sliding direction (X). Further, the gripping device (31) is movable along the transverse direction (T) already indicated above, which is substantially horizontal and perpendicular to the sliding direction (X). Preferably, the support structure (4) is movable along said transverse direction (T), and the gripping device (31) is integrally movable with the support structure (4) along the transverse direction (T).

The configuration of the manipulator (3) enables the gripping device (31) to be moved with significant freedom inside a working space defined substantially by the available stroke for the carriage (30) along the sliding direction (X), by the stroke available for the support structure (4) along the transverse direction (T), perpendicular to the sliding direction (X), and by the stroke available for the gripping device (31) on the movement plane (M) along the ascent-descent direction (T1). In practice, the gripping device can reach any position defined by three coordinates corresponding to three intermediate points of the strokes available for the carriage (30) along the sliding direction (X), for the support structure (4) along the transverse direction (T) and for the gripping device (31) on the movement plane (M) along the ascent-descent direction (T1). Further, the gripping device (31) can be oriented in a desired manner around the rotation axis (Z).

In practice, thanks to the coordinated combination of the movements of the carriage (30), of the support structure (4) and of the gripping device (31), it is possible to move the slab (L) with significant freedom. In particular, the gripping device (31) is arranged to translate along the transverse direction (T). This enables the slabs (L) to be moved from the accessory position (D) to the containing spaces (22), and vice versa, with considerable freedom.

In the illustrated preferred but not exclusive embodiment, the movement of the gripping device (31) along the transverse direction (T) is obtained by the movement of the support structure (4) along the transverse direction (T). In particular, the support structure (4) is associated with the carriage (30) with the possibility of translation along the transverse direction (T). To this end, the uprights (41a, 41b) are connected to the carriage (30) slidably along the transverse direction (T).

In the illustrated preferred but not exclusive embodiment, the gripping device (31) comprises a frame (31a) associated with the support structure (4) rotatably around the rotation axis (Z).

A gripping means comprising for example a plurality of suction cups is associated with the frame (31a). The suction cups have respective gripping surfaces, i.e. surfaces intended to come into contact with and adhere to the object to be supported, in a manner that is well known in the industry. These active surfaces face in the same direction and lie on the gripping plane (P) of the gripping means.

By rotating the frame (31a) around the rotation axis (Z), the gripping plane of the gripping device (31) rotates around the rotation axis (Z). In this mode, it is possible to also rotate a slab (L) supported by the gripping means by changing the orientation thereof in space. This enables a slab (L) to be picked up that is arranged resting on the operating station (D), for example in a horizontal position, and after the slab (L) is raised, enables the slab (L) to be rotated to a preset angular position, lying on a plane that is substantially parallel to the rest plane (C), to place the slab (L) in a containing space (22).

The frame (31a) is rotated around the rotation axis (Z) by a motor (4a), of a type that is known in the industry, associated with the support structure (4).

In the embodiment shown, the frame (31a) comprises a plurality of bars, connected together to form a substantially rectangular surrounding structure that has connecting means for the suction cups. The latter are connected to the frame (31a) by means of respective arms (31b). Preferably, the arms (31b) can slide and be locked in variable positions along the rotation axis (Z). Further, the suction cups can be placed along the respective arms (31b) in variable positions transversely to the rotation axis (Z). This allows the suction cups to be positioned and/or spatially distributed optimally with respect to the sizes and the shape of the slabs (L).

The carriage (30) is associated with a main frame (1) of the sorting machine, slidably along the sliding direction (X).

In a manner known in the industry, the main frame (1) is structured for resting on the ground or on a baseplate. In the depicted embodiment, the main frame comprises two upper spars (11), arranged parallel to the sliding direction (X), with which the carriage (30) is slidably associated. Sliding guides are interposed between each spar (11) and the carriage (30). The upper spars (11) are supported by a plurality of vertical uprights, arranged to be anchored to the ground or to a baseplate. Additional cross members can be arranged to connect the uprights together, in case it is necessary to increase the stiffness of the main frame (1).

The sliding of the carriage (30) is obtained by means of a motor, known in the industry. Thanks to the sliding coupling with the upper spars (11), the carriage (30) is supported stably and precisely by the main frame (1).

The carriage (30) is located at a greater height than the accessory position (D). The support structure (4) is located below the carriage (30). In particular, the uprights (41a, 41b) are associated with the carriage (30) at one end, and extend vertically below the carriage (30).

The carriage (30) comprises at least one cross member (32), arranged substantially horizontally and perpendicularly to the sliding direction (X). The cross member (32) is connected, at the ends, to two plates (33) that are slidable along the upper spars (11).

Each upright (41a, 41b) is associated with the cross member (32) slidably along the transverse direction (T). In particular, each upright (41a, 41b) is associated with the cross member (32) at one end, and extends vertically below the cross member (32) itself. Sliding guides are interposed between each upright (41a, 41b) and the cross member (31). The sliding of each upright (41a, 41b) along the respective cross member is obtained by means of a motor of known type.

In the illustrated preferred but not exclusive embodiment, the carriage (30) comprises two cross members (32) that are parallel to one another and are associated, at the respective ends, with the plates (33). The uprights (41a,41b) are associated with a support frame (43,44), slidably associated with the cross members (32). The support frame (43,44) comprises two brackets (43), each of which is associated with a respective upright (41a,41b), which are slidingly constrained to one or both the cross members (32). The brackets (43) are connected together by a bar (44), which makes the brackets (43) solidly joined at least with respect to the sliding along the transverse direction (T). Thanks to the parts disclosed above, the structure of the carriage (30) is therefore stiff and resistant.

In the illustrated preferred but not exclusive embodiment, the accessory position (D) is a movable station. In particular, the accessory position (D) is located on a conveying plane (2). Preferably, the conveying plane (2) is movable along a conveying direction parallel to the longitudinal direction (Y).

In the depicted embodiment, the conveying plane (2) comprises a belt conveyor, known in the industry. In summary, the conveying plane (2) comprises a pair of motor-driven belts, closed in a loop around a path defined by a series of pulleys. Along at least one upper section of the followed path, the belts lie on a horizontal plane and are parallel to each other and to the conveying direction. The embodiment of the conveying plan (2) is however not decisive for the purposes of the present invention, and could be structured in a different manner that is known in the industry. For example, the conveying plane (2) could comprise a motor-driven roller conveyor or a motor-driven belt.

The conveying plane (2) is intended to support the slabs (L) and move the slabs (L) forward along the conveying direction. One or more accessory stations (D) can be defined or located on the conveying plane (2). In particular, an accessory position (D) can be identified in any zone of the conveying plane (2) that is suitable for supporting a slab (L).

In particular, in one operating cycle for inserting the slabs (L) into the plant, a series of slabs (L) is fed to the manipulator (3) by the conveying plane (2). Each slab (L) is arranged in an accessory position (D), i.e. in a position that is reachable by the gripping device (31). The gripping device (31) picks up the slabs (L) from the conveying plane (2) and moves the slabs (L) to respective containing spaces (22), which are chosen on the basis of set sorting criteria. In an opposite operating cycle, in order to extract the slabs (L) from the plant, the gripping device (3) picks up the slabs (L) from the respective containing spaces (22) and takes the slabs (L) to the conveying plane (2), depositing the slabs (L) on the latter in succession, each slab (L) being placed in an accessory position (D). In the embodiment shown, the conveying plane (2) is located between two racks (20) parallel to the longitudinal direction (Y). In this case, the gripping device (31) is able to insert itself into each containing space (22) of both racks (20).

The combination of the possible movements allows the gripping device (31) to reach a position on the conveying plane (2), for picking up or releasing a slab (L), and a containing space (22) located alongside the conveying plane (2), for depositing or picking up a slab (L). For example, assuming to start from an initial position illustrated in FIG. 2, in which the gripping device (31) is located substantially in its first position, namely is positioned substantially above the conveying plane (2) for picking up a slab (L) resting on the conveying plane (2) in a horizontal position, it is possible to transfer the slab (L) to a containing space (22) by taking the gripping device (31) to its second position through a coordinated combination of the following movements, which can also take place simultaneously with each other, at least for some time intervals and not necessarily in the order indicated below:
movement of the carriage (30) along the sliding direction (X);
movement of the gripping device (31) along the ascent-descent direction (T1);
rotation of the gripping device (31) around the rotation axis (Z);
movement of the gripping device (31) along the transverse direction (T).

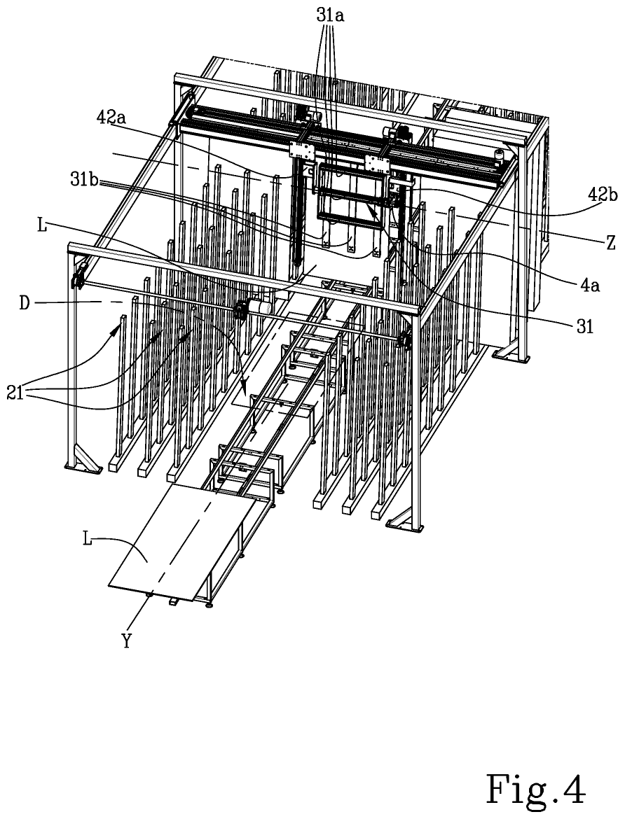

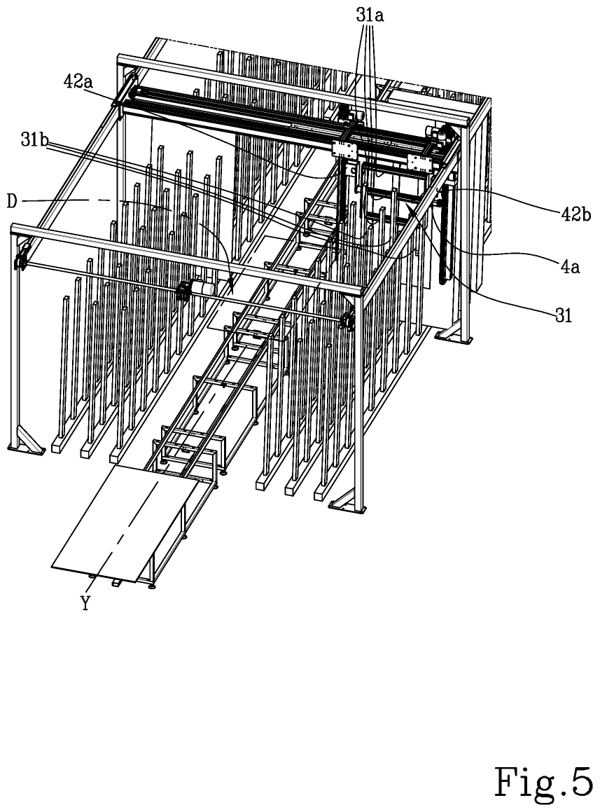

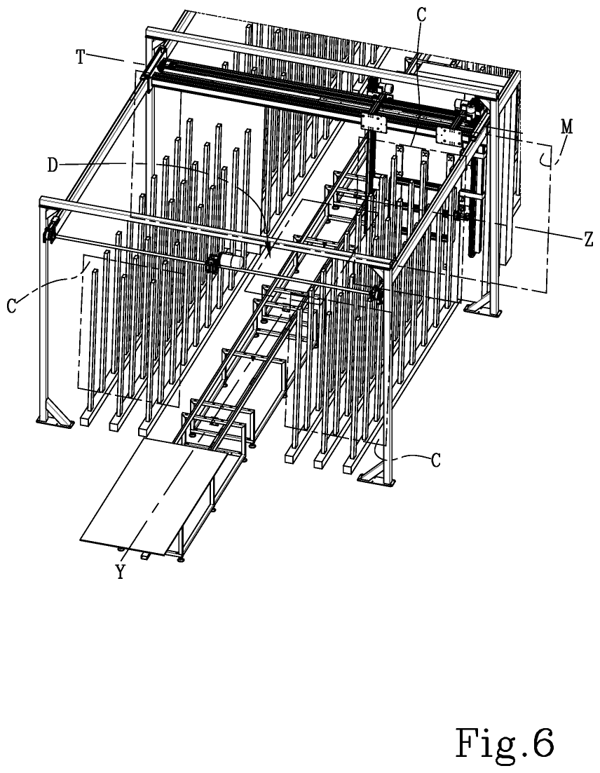

In the typical operating cycle shown in FIGS. 2 to 8, after hooking a slab (L), the gripping device (31) follows an operating path from the first position on the conveying plane (2) to the second position, inside a set containing space (22), which comprises at least one component for lifting from the conveying plane (2) followed by at least one component for lowering inside a set containing space (22). During the operating path, before being inserted into the set containing space (22), the gripping device (31) rotates around the rotation axis (Z), taking the gripping plane (P) from a substantially horizontal position to the insertion position that is substantially parallel to the rest plane (C).

The slabs (L) can be picked up and deposited during an arrest stop of the conveying plane (2), i.e. the conveying plane can be temporarily stopped during depositing or picking up of a slab (L) by the gripping device (31), or can be picked up and deposited during the motion of the conveying plane (2), i.e. without the need to stop the conveying plane (2). In this case, the gripping device (31) follows the conveying plane (2) synchronously during the steps of picking up or depositing a slab (L), i.e. the gripping device (31) performs a movement along the sliding direction (X), parallel to the longitudinal direction (Y), which for at least one portion is parallel to and at the same speed as the conveying plane (2).

The transfer of the slab (L) from the conveying plane (2) to the provided containing space (22) takes place substantially at a higher level than the conveying plane (2), except for a final lowering of the slab (L) to be placed resting in the envisaged containing space (22).

In a possible alternative embodiment of the plant, which is not illustrated, the accessory position is located in a vehicle, like for example an automatically driven carriage or vehicle. The vehicle is provided with a loading plane, which is suitable for supporting one or more slabs arranged resting on a horizontal plane or on a tilted plane. In this alternative embodiment of the plant, the vehicle is guided to an access position in which the vehicle can be reached by the gripping device (31). In this access position, the gripping device (31) reaches the accessory position located on the vehicle and through the already disclosed movements deposits or picks up a slab (L). Subsequently the vehicle continues along a set path towards subsequent destinations. The plant can be provided with a plurality of vehicles of the type summarized above, each guidable to at least one access position in which the vehicle can be reached by the gripping device (31).

In a manner known in the industry, the automatic warehouse according to the present invention comprises a main control system, arranged to identify each slab (L) introduced into the warehouse and to match each identified slab (L) with a containing space (22). The main control system also governs the operation of the manipulator (3), to take it to a specific containing space (22) in which to deposit or pick up a slab (L). The operations of introducing and extracting the slabs (L) can thus be managed automatically.

The criteria for choosing and sorting the slabs (L), or the criteria for distributing the slabs (L) in specific containing spaces (22), can be of different types. For example, the slabs (L) can be sorted and grouped together based on the colour, the actual sizes, the presence of more or less marked defects. In order for the parameter chosen for sorting to be evaluated, a system for viewing and analysing the slabs (L) can be arranged along the conveying plane (2), upstream of the manipulator device. This viewing and analysis system is known in the industry in some different modes of implementation, and is connected to a main control system that governs the operation of the sorting machine.

In a manner known in the industry, the main control system mentioned in the present description and in the following claims is generically referred to as a single unit, but can in fact be provided with distinct functional modules (memory modules or operating modules), each responsible for controlling a given device or cycle of operations. In substance, the main control system can consist of a single electronic device, programmed to carry out the functions described, and the various functional modules can correspond to hardware and/or routine software entities which are part of the programmed device. Alternatively, or additionally, such functions can be performed by a plurality of electronic devices over which the aforesaid functional modules can be distributed. The units can further rely on one or more processors for the execution of the instructions contained in the memory modules. Further, the units and the aforesaid functional modules can be distributed over different local or remote calculators on the basis of the architecture of the network in which they reside.

1. A sorting and storage plant for slabs, comprising:
a warehouse provided with a plurality of containing spaces;
a manipulator, set up for grasping and releasing a slab, and for displacing the slab between an accessory position and one or more containing spaces;
wherein:
the warehouse comprises at least one rack, provided with a plurality of sidewalls arranged transversely to a longitudinal direction and parallel to one another;
each sidewall defines a rest plane that is oriented with a small tilt with respect to a vertical plane;
two consecutive sidewalls face one another and define a containing space for one or more slabs arranged substantially parallel to the rest plane;
the manipulator comprises a gripping device, associated in a movable manner with a support structure that defines a displacement plane of the gripping device;
the displacement plane is parallel to the rest plane, to enable the gripping device to be inserted into a containing space, in order to release or pick up a slab.

2. The plant according to claim 1, wherein the gripping device comprises a gripping plane and rotates around a rotation axis, lying on the displacement plane, to adopt at least one inserting position in which the gripping plane is parallel to the rest plane, and a second position, in which the gripping plane has a different tilt from the insertion position.

3. The plant according to claim 1, wherein the gripping device movable on the displacement plane along at least two perpendicular directions.

4. The plant according to claim 1, wherein the support structure comprises at least one upright arranged lying on the displacement plane.

5. The plant according to claim 4, wherein the gripping device is slidable along the upright.

6. The plant according to claim 5, wherein the support structure comprises a slider, slidable along the upright, with which the gripping device rotating around the rotation axis is associated.

7. The plant according to claim 6, wherein the support structure comprises a second upright, substantially parallel to and coplanar with the first upright, and a second slider, slidable along the second upright, with which the gripping device rotating around the rotation axis is associated so that the gripping device is comprised between the two uprights.

8. The plant according to claim 7, wherein the first slider and the second slider comprise a respective arm; the arms are coplanar with the displacement plane and protrude downwards relative to the rotation axis.

9. The plant according to claim 1, wherein the manipulator comprises a carriage, movable along a substantially horizontal sliding direction, with which the support structure is associated.

10. The plant according to claim 9, wherein the support structure is movable along a transverse direction substantially horizontal and perpendicular to the sliding direction.

11. The plant according to claim 10, wherein the sliding direction is parallel to the longitudinal direction.

12. The plant according to claim 1 comprising a conveying device, set up to displace the slabs along at least one conveying direction parallel to the longitudinal direction, wherein said accessory position is arranged on the conveying device.
